(19) United States
(12) Patent Application Publication
(10) Pub. No.: US 2009/0099281 A1
(43) Pub. Date: Apr. 16, 2009

(54) Rubber Composition And Pneumatic Tire

(75) Inventors: Takashi Sakurai, Osaka (JP); Hirofumi Hayashi, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/245,911

(22) Filed: Oct. 6, 2008

(30) Foreign Application Priority Data
Oct. 12, 2007 (JP) 2007-266249

(51) Int. Cl. C08L 97/00

(52) U.S. Cl. 524/76

(57) ABSTRACT

A rubber composition that can improve rolling resistance of tires without impairing running performances such as braking performance, driveability (grip performance), abrasion resistance and the like, and a pneumatic tire using the same are provided. The rubber composition includes a diene rubber as a rubber component, and lignin derivatives.

### CROSS-REFERENCE TO RELATED APPLICATIONS

This application is based upon and claims the benefit of priority from the prior Japanese Patent Application No. 2007-266249, filed on Oct. 12, 2007; the entire contents of which are incorporated herein by reference.

### BACKGROUND

The present invention relates to a rubber composition that improves rolling resistance of tires, improves durability, and additionally can reduce inherent smell of rubber in the production of tires.

Rubber compositions used in, for example, treads of pneumatic tires are strongly required to reduce rolling resistance from commercial needs of low fuel consumption. Furthermore, improvement of braking performance and driveability (grip performance), resistance to oxidative degradation, durability, and excellent abrasion resistance in the points of economic efficiency are required in rubber compositions.

In recent years, earth-conscious materials are also required for rubber compositions. For example, lignin which is a main component of wood together with cellulose and hemicellulose is a material occurring in rich in nature obtained from a pulping eluate as a raw material by-produced at the time of pulp production. Sulfonated metal salts of lignin have functions of dispersibility, adhesion, chelatability and the like, and its effect is expected.

It is known that lignin is used as a tackifier of rubber compositions. However, U.S. Pat. No. 5,196,460 A discloses that lignin is not used to improve rubber characteristics. Furthermore, U.S. Pat. No. 5,967,211 A discloses that grip properties on frozen passage are improved by compounding cellulose fibers containing lignin. Thus, it is considered that cellulose fibers having a specific aspect ratio exhibit grip properties.

In recent years, silica formulation is used as a reinforcing agent for rubbers in view of adverse influence to environment or human body, and particularly due to recent low fuel consumption orientation. In such a case, viscosity of an unvulcanized rubber is increased, and a dispersing agent having high plasticizing effect is more and more required in the points of dispersibility of silica, processability and the like.

### SUMMARY

According to the embodiments of the present invention, there is provided a rubber composition that can improve rolling resistance of tires without impairing running performances such as braking performance, driveability (grip performance), resistance to oxidative degradation, abrasion resistance and the like by compounding lignin derivatives excellent in safety and environmental aspects obtained from wood, particularly lignin sulfonic acid or lignin sulfonic acid derivatives as its sulfonated compound, with the rubber composition and a pneumatic tire using the same.

As a result of earnest studies to overcome the above problems, it has been found that lignin sulfonic acid or lignin sulfonic acid derivatives improve dispersibility of a reinforcing agent such as carbon black or silica, and are capable of improving rubber properties of the rubber composition. Furthermore, a lignin structure has a polyphenol, and resistance to oxidative degradation of the rubber composition is improved by the effect of antioxidation property of the polyphenol. It has been further found that lignin sulfonic acid or lignin sulfonic acid derivatives reduce inherent smell of rubber at the time of the production of rubber products, such as mixing step, vulcanization step or the like.

As one embodiment, the present invention provides a rubber composition comprising a diene rubber as a rubber component, and a lignin derivative.

The lignin derivative is preferably lignin sulfonic acid or a lignin sulfonic acid derivative.

The lignin sulfonic acid derivative may be a lignin sulfonate and the lignin sulfonate preferably comprises at least one of alkali metal salts and alkaline earth metal salts of lignin sulfonic acid.

The rubber composition of the present invention can exerts its advantage significantly by containing the lignin derivative in an amount of from 0.1 to 30 parts by weight per 100 parts by weight of the rubber component.

As another embodiment, the present invention provides a pneumatic tire using the rubber composition as at least a part thereof.

According to the present invention, rubber properties of a rubber composition are improved by that lignin derivatives improve dispersibility of a reinforcing agent such as carbon black or silica, and rolling resistance of tires are improved and low fuel consumption is promoted, without impairing running performances such as braking performance, driveability (grip performance) or abrasion resistance. Furthermore, the lignin structure has a polyphenol, and by the effect of antioxidative property of the polyphenol, resistance to oxidative degradation of the rubber composition is improved. Moreover, inherent smell of rubber at the time of the production of rubber products including mixing and vulcanization steps is reduced, and working environment and environmental problems generating near the factory can be improved.

### DETAILED DESCRIPTION

The embodiments of the present invention are described below.

The rubber composition according to the embodiments of the present invention uses a diene rubber as a rubber component.

The diene rubber comprises a natural rubber (NR), an epoxydized natural rubber (ENR) and a synthetic diene rubber. Examples of the synthetic diene rubber include a styrene-butadiene rubber (SBR), a polybutadiene rubber (BR), a polyisoprene rubber (IR), an ethylene-propylene-diene rubber (EPDM), a chloroprene rubber (CR), an acrylonitrile-butadiene rubber (NBR) and a butyl rubber. Those diene rubbers may be contained alone or as mixtures thereof.

The rubber composition according to the embodiments of the present invention preferably contains lignin sulfonic acid or lignin sulfonic acid derivatives as lignin derivatives. The lignin sulfonic acid derivatives are preferred, and the lignin sulfonic acid derivatives preferably are a lignin sulfonate.

Examples of the lignin sulfonate include alkali metal salts or alkaline earth metal salts of lignin sulfonic acid. At least one of those salts is preferably used. Specific examples of the salts include potassium salts, sodium salts, calcium salts, magnesium salts, lithium salts and barium salts. Mixed salts of those may be used.

Examples of the lignin sulfonic acid derivatives include ester salts, ammonium salts, alcohol amine salts and alkyl salts of lignin.

The lignin is preferably lignin obtained by a sulfite pulp method or a kraft pulp method.

The lignin sulfonate is a polyelectrolyte having a functional group such as a sulfonic group, a carboxyl group or a phenolic hydroxyl group. The lignin sulfonate chemically or physically adsorbs on a reinforcing agent such as carbon black or silica in a rubber composition, and can improve the dispersibility of the reinforcing agent. This makes it possible to exhibit rubber characteristics, particularly low rolling resistance, of the rubber composition.

Furthermore, the lignin sulfonate has a hydrophobic group and a hydrophilic group, and therefore can contribute to improvement of processability of the rubber composition. Additionally, the lignin sulfonate further has a phenolic hydroxyl group, and therefore can contribute to improvement of resistance to oxidative degradation of the rubber composition.

The lignin sulfonate may contain saccharides such as monosaccharides or polysaccharides. Examples of the saccharides include cellulose of wood component, glucose as a structural unit of cellulose, and a polymer of glucose, and specific examples thereof include hexose, pentose, mannose, galactose, ribose, xylose, arabinose, lyxose, ribose, talose, altrose, allose, gulose, idose, starch, starch hydrolyzate, dextran, dextrin and hemicellulose.

The content of saccharides in the lignin sulfonate is from 0 to 50% by weight, and preferably 40% by weight or less. Saccharides may be removed by purification.

The compounding mount of lignin sulfonic acid or lignin sulfonic acid derivatives in the invention is preferably from 0.1 to 30 parts by weight per 100 parts by weight of the rubber component. Where the amount of lignin sulfonic acid or lignin sulfonic acid derivatives is less than 0.1 parts by weight, an effect of improving dispersibility of a reinforcing agent or the like is not sufficient, and where the amount exceeds 30 parts by weight, abrasion resistance tends to deteriorate.

The rubber composition of the invention can use a reinforcing agent for rubber, such as carbon black or silica. Carbon black and silica may be used in combination.

The carbon black is not particularly limited. For example, carbon black having colloidal characteristics that nitrogen adsorption specific surface area (BET) is from 25 to 160 m²/g and DBP absorption is 80 ml/100 g or more can be used. BET of carbon black is measured according to the method described in JIS K6217-2, and DBP absorption is measured according to the method described in JIS K6217-4.

Examples of such a carbon black include various grades such as N110, N220, N330, N550 or N660 in ASTM number.

The compounding amount of the carbon black is from about 0 to 150 parts by weight per 100 parts by weight of the rubber component. Where the compounding amount of the carbon black exceeds 150 parts by weight, heat build-up deteriorates, and processability is decreased.

The silica preferably has, for example, colloidal characteristics that nitrogen adsorption specific surface area (BET) is 250 m²/g or less and DBP absorption is 250 ml/100 g or less. By using silica having such a large particle diameter and small structure, processability can be maintained, and additionally, heat build-up can be suppressed, and rolling resistance can be reduced.

The compounding amount of the silica is preferably from about 20 to 120 parts by weight per 100 parts by weight of the rubber component. Where the compounding amount of silica is less than 20 parts by weight, an effect of reducing rolling resistance cannot sufficiently be exhibited.

The silica is not particularly limited so long as the colloidal characteristics as described above are satisfied. Examples of the silica include wet silica (hydrous silicic acid), dry silica (anhydrous silicic acid), calcium silicate and aluminum silicate. Of those, wet silica combining fracture characteristics and low rolling resistance is preferred, and the wet silica is further preferred from the point of excellent productivity. The commercially available products that can be used as the silica include NIPSEAL AQ and VN3, manufactured by Tosoh Silica Corporation; PR and USG-A, manufactured by Tokuyama Corporation; and ULTRASIL VN3, manufactured by Degussa. BET of silica is measured according to BET method described in ISO 5794, and DBP absorption is measured according to the method described in JIS K6221.

Furthermore, surface-treated silica surface-treated with amines, organic polymers or the like to improve affinity with a polymer may used as the silica.

When silica is used, a silane coupling agent is preferably used in an amount of from 2 to 20% by weight, and more preferably from 2 to 15% by weight, based on the weight of the silica. Examples of the silane coupling agent include sulfur-containing silane coupling agent such as bis(3-triethoxysilylpropyl)tetrasulfide or bis(3-triethoxysilylpropyl)disulfide; and protected mercaptosilane represented by the following formula (1):

(CₓH₂ₓ₊₁O)₃Si—(CH₂)_{y}—S—CO—C_{z}H_{2z+1} (1)

wherein x is an integer of from 1 to 3, y is an integer of from 1 to 5, and z is an integer of from 5 to 9.

According to need, other than the above components, various compounding ingredients such as processing oils, zinc white, stearic acid, waxes, age resisters, vulcanizing agents, vulcanization accelerators, vulcanization aids or resins, generally used in tire industry can appropriately be compounded with the rubber composition according to the aspect of the present invention in a range that the advantage of the invention is not impaired.

The rubber composition according to the aspect of the present invention can be produced according to the conventional methods by compounding various compounding ingredients with the starting rubber and lignin sulfonate using various keanding machines such as Banbury mixer, rolls or kneaders, and can be used in each site of tires, such as side wall or bead portion, including tread of tires.

By compounding the lignin sulfonate, the rubber composition according to the aspect of the present invention can exhibit an effect that smell of vanilla possessed by the lignin sulfonate removes smell of rubber, can reduce inherent smell of rubber generated at the time of mixing or vulcanization, and additionally at the time of storage and use of vulcanized tires, and can improve working environment and environmental problems generating near the factory.

### EXAMPLES

The present invention is described below by reference to the following examples, but the invention is not limited to those examples.

### Preparation of Rubber Composition

Styrene-butadiene rubber/polybutadiene rubber (SBR/BR) blend type, natural rubber/polybutadiene rubber (NR/BR) blend type and natural rubber/epoxydized natural rubber (NR/ENR) blend type rubber compositions were prepared as a rubber component of a rubber composition. Lignin sulfonic acid sodium salts (lignin sulfonic acid-1 and 2) and lignin sulfonic acid calcium salt (lignin sulfonic acid-3) shown in Table 1 below were used as lignin sulfonate. Anionic surfactants (surfactant-1 and 2) having dispersion effect shown below were used as Comparative Examples.

TABLE 1

| | Lignin sulfonate | | |
|---|---|---|---|
| | 1 | 2 | 3 |
| Kind of salt | Sodium salt | Sodium salt | Calcium salt |
| lignin sulfonic acid (%) | 91 | 58 | 60 |
| Content of saccharide (%) | 0 | 38 | 37 |
| Inorganic salt content (%) | 9 | 4 | 3 |
| Trade name*1 | VANILLEX N | SANX P252 | SANX SCP |

*1: Manufactured by Nippon Paper Chemicals Co., Ltd.

### Anionic Surfactant

Surfactant-1: Sodium lauryl sulfate (EMAL 10 POWDER, manufactured by Kao Corporation)

Surfactant-2: Polyoxyethylene alkyl ether sodium sulfate (EMAL D-4-D, manufactured by Kao Corporation)

Each rubber composition was prepared according to the compounding formulations (parts by weight) shown in Table 2 (SBR/BR type), Table 3 (NR/BR type), Table 4 (NR/ENR type) and Table 5 (NR type) below. Each rubber component and each compounding component are as follows.

### Rubber Component

Natural rubber (NR): RSS#3 (made in Malaysia)

Styrene-butadiene rubber (SBR): TUFDENE E-50, manufactured by Asahi Kasei Corporation

Polybutadiene rubber (BR): BR01, manufactured by JSR Corporation

Epoxydized natural rubber (ENR): 25% epoxydized natural rubber EPOXY PRENE 25, manufactured by MMG

### Compounding Ingredient

Silica: NIPSEAL AQ, manufactured by Tosoh Silica Corporation

Silane coupling agent: Si-69, manufactured by DEGUSSA

Carbon black: SHOW BLACK N330, manufactured by Cabot Japan

Zinc white: Zinc White #1, manufactured by Mitsui Mining & Smelting Co., Ltd.

Stearic acid: LUNAX S20, manufactured by Kao Corporation

Aroma oil: PROCESS X-140, manufactured by Japan Energy Corporation

Age resister 6C: SANTOFLEX 6PPD, manufactured by Flexsys

Wax: OZOACE 0355, manufactured by Nippon Seiro Co., Ltd.

Sulfur: Powdery sulfur for rubber 150 mesh, manufactured by Hosoi Chemical Industry Co., Ltd.

Vulcanization accelerator CZ: NOCCELLAR CZ-G, manufactured by Ouchi Shinko Chemical Industrial Co., Ltd.

### Evaluation

Each rubber composition obtained was applied to a cap tread of a tire having a tread of a cap/base structure, and a radial tire of 205/65R15 94H was produced according to the ordinary method. Each tire obtained was evaluated in abrasion resistance, braking characteristics (grip performance), rolling resistance characteristics, and tear resistance. Each rubber composition was evaluated in retention of elongation at break after aging as heat-resistant characteristics, smell of rubber in a mixing step, and processability. Each evaluation method is as follows. The results obtained are shown in Table 2 (SBR/BR type), Table 3 (NR/BR type), Table 4 (NR/ENR type) and Table 5 (NR type) below.

### Abrasion Resistance

Two kinds of the above radial tires were adjusted to an inner pressure of 200 kPa and mounted to front wheels and rear wheels of 2000 cc domestic front-wheel-drive cars, respectively. Cars were run 20,000 km on general road while conducting tire rotation every running distance of 5,000 km. The residual depth of tread of each tire was measured to obtain depth of wear, and abrasion resistance was evaluated. The abrasion resistance is indicated by an index as values of Comparative Examples 1, 5, 7 and 9 in each Table being 100. The abrasion resistance is excellent as the index is large.

### Braking Characteristics

Using a rim of 15×6.5 JJ and adjusting air pressure to 230 kPa, four radial tires were mounted to a 2000 cc domestic front-wheel-drive car. The car was run on an asphalt pavement surface. ABS was activated at 90 km per hour, and braking distance at slowdown up to 20 km/hr was measured. The braking distance is indicated by an index as values of Comparative Examples 1, 5, 7 and 9 in each Table being 100. The braking characteristics are excellent as the index is large.

### Rolling Resistance Characteristics

A rim of 15×6.5 JJ was used, and a tire was mounted thereto. Rolling resistance was measured when running with a single-axis drum tester for rolling resistance measurement at 80 km/hr at 23° C. with air pressure of 230 kPa under load 450 kgf. The rolling resistance was indicated by an index as values of Comparative Examples 1, 5, 7 and 9 in each Table being 100. Smaller index shows that rolling resistance is small, and therefore fuel efficiency is excellent.

### Tear Resistance

A car having mounted thereof the above tires was repeatedly subjected to run-on test 10 times to a curb for run-on test. The product (addition of areas) of the number of tears formed on the tread surface and a size (length×depth) of each scratch was obtained, and relative comparison was made. The tear resistance is indicated by an index as values of Comparative Examples 1, 5, 7 and 9 in each Table being 100. The tear resistance is excellent as the index is large.

### Retention of Elongation at Break

Each rubber composition was rolled into a sheet, and vulcanized with heat press at 150° C. for 30 minutes to produce a vulcanized rubber sheet having a thickness of 2 mm. Elongation at break (EB) before aging and after aging (test specimen was allowed to stand in a gear oven at 100° C. for 7 days) was measured according to JIS K6301 (No. 3 dumbbell is used) to obtain EB retention after aging. The EB retention is indicated by an index as values of Comparative Examples 1, 5, 7 and 9 in each Table being 100. Heat resistance is excellent as the index is large.

### Smell of Rubber

Bunbary mixer having a volume of 200 liters was used, and smell of rubber during mixing each rubber composition therein was evaluated by ten panelists on the basis of Comparative Example 1. Comparative Example 1 was indicated as “Poor”, the case that inherent smell of rubber is smaller than Comparative Example 1 was indicated as “Good”, the case that smell of rubber is extremely small was indicated as “Excellent”, and the case that smell of rubber is strong was indicated as “Bad”.

### Processability

Mooney viscosity (ML₁₊₄) at 100° C. of each rubber composition was measured according to JIS K6300, and indicated by an index as values of Comparative Examples 1, 5, 7 and 9 in each Table being 100. The viscosity is smaller as the value is smaller, and therefore the processability is better.

TABLE 2

| | Comparative | Comparative | Comparative | Comparative | | | | |
|---|---|---|---|---|---|---|---|---|
| | Example 1 | Example 2 | Example 3 | Example 4 | Example 1 | Example 2 | Example 3 | Example 4 |
| SBR | 65 | 65 | 65 | 65 | 65 | 65 | 65 | 65 |
| BR | 35 | 35 | 35 | 35 | 35 | 35 | 35 | 35 |
| Lignin sulfonate-1 | | | | 40 | 3 | | | 10 |
| Lignin sulfonate-2 | | | | | | 3 | | |
| Lignin sulfonate-3 | | | | | | | 3 | |
| Surfactant-1 | | 3 | | | | | | |
| Surfactant-2 | | | 3 | | | | | |
| Silica | 80 | 80 | 80 | 80 | 80 | 80 | 80 | 80 |
| Silane coupling agent | 6.4 | 6.4 | 6.4 | 6.4 | 6.4 | 6.4 | 6.4 | 6.4 |
| Carbon black | 5 | 5 | 5 | 5 | 5 | 5 | 5 | 5 |
| Zinc white | 2 | 2 | 2 | 2 | 2 | 2 | 2 | 2 |
| Stearic acid | 2 | 2 | 2 | 2 | 2 | 2 | 2 | 2 |
| Oil | 40 | 40 | 40 | 40 | 40 | 40 | 40 | 40 |
| Age resister | 2 | 2 | 2 | 2 | 2 | 2 | 2 | 2 |
| Wax | 2 | 2 | 2 | 2 | 2 | 2 | 2 | 2 |
| Sulfur | 2 | 2 | 2 | 2 | 2 | 2 | 2 | 2 |
| Vulcanization accelerator | 2 | 2 | 2 | 2 | 2 | 2 | 2 | 2 |
| Abrasion resistance (Index) | 100 | 86 | 90 | 72 | 100 | 103 | 99 | 98 |
| Braking properties (Index) | 100 | 95 | 96 | 105 | 102 | 102 | 103 | 102 |
| Rolling resistance (Index) | 100 | 100 | 102 | 82 | 94 | 96 | 97 | 89 |
| EB retention (Index) | 100 | 95 | 98 | 115 | 107 | 109 | 112 | 116 |
| Smell rubber | Poor | Poor | Poor | Excellent | Good | Good | Excellent | Excellent |
| Processability | 100 | 105 | 103 | 80 | 93 | 92 | 95 | 90 |

TABLE 3

| | Comparative | Comparative | | | | | | |
|---|---|---|---|---|---|---|---|---|
| | Example 5 | Example 6 | Example 5 | Example 6 | Example 7 | Example 8 | Example 9 | Example 10 |
| NR | 60 | 60 | 60 | 60 | 100 | 60 | 100 | 60 |
| BR | 40 | 40 | 40 | 40 | | 40 | | 40 |
| Lignin sulfonate-1 | | | 3 | 10 | 3 | | | 10 |
| Lignin sulfonate-2 | | | | | | 3 | 3 | |
| Lignin sulfonate-3 | | | | | | | | 3 |
| Surfactant-1 | | 3 | | | | | | |
| Carbon black | 40 | 40 | 40 | 40 | 40 | 40 | 40 | 40 |
| Zinc white | 2 | 2 | 2 | 2 | 2 | 2 | 2 | 2 |
| Stearic acid | 2 | 2 | 2 | 2 | 2 | 2 | 2 | 2 |
| Age resister | 2 | 2 | 2 | 2 | 2 | 2 | 2 | 2 |
| Wax | 1 | 1 | 1 | 1 | 1 | 1 | 1 | 1 |
| Sulfur | 1.5 | 1.5 | 1.5 | 1.5 | 1.5 | 1.5 | 1.5 | 1.5 |
| Vulcanization accelerator | 1 | 1 | 1 | 1 | 1 | 1 | 1 | 1 |
| Tear resistance (Index) | 100 | 98 | 100 | 98 | 99 | 160 | 157 | 140 |
| Rolling resistance (Index) | 100 | 105 | 97 | 94 | 96 | 97 | 97 | 96 |
| EB retention (Index) | 100 | 95 | 106 | 110 | 104 | 109 | 107 | 105 |
| Smell rubber | Poor | Poor | Good | Excellent | Good | Good | Good | Good |
| Processability | 100 | 115 | 97 | 95 | 98 | 99 | 97 | 97 |

TABLE 4

| | Comparative | Comparative | Example | Example |
|---|---|---|---|---|
| | Example 7 | Example 8 | 11 | 12 |
| NR | 60 | 60 | 60 | 60 |
| ENR | 40 | 40 | 40 | 40 |
| Lignin sulfonate-1 | | | 3 | |
| Lignin sulfonate-2 | | | | 3 |
| Surfactant-1 | | 3 | | |
| Silica | 80 | 80 | 80 | 80 |
| Silane coupling | 6.4 | 6.4 | 6.4 | 6.4 |
| agent | | | | |
| Carbon black | 5 | 5 | 5 | 5 |
| Zinc white | 2 | 2 | 2 | 2 |
| Stearic acid | 2 | 2 | 2 | 2 |
| Oil | 15 | 15 | 15 | 15 |
| Age resister | 2 | 2 | 2 | 2 |
| Wax | 2 | 2 | 2 | 2 |
| Sulfur | 2 | 2 | 2 | 2 |
| Vulcanization | 2 | 2 | 2 | 2 |
| accelerator | | | | |
| Abrasion | 100 | 96 | 102 | 100 |
| resistance (Index) | | | | |
| Braking | 100 | 94 | 102 | 105 |
| properties (Index) | | | | |
| Rolling | 100 | 100 | 95 | 97 |
| resistance (Index) | | | | |
| EB retention (Index) | 100 | 100 | 110 | 109 |
| Smell rubber | Poor | Poor | Good | Good |
| Processability | 100 | 109 | 95 | 95 |

TABLE 5

| | Comparative | Comparative | Example | Example |
|---|---|---|---|---|
| | Example 9 | Example 10 | 13 | 14 |
| NR | 100 | 100 | 100 | 100 |
| Lignin sulfonate-1 | | | 3 | |
| Lignin sulfonate-2 | | | | 3 |
| Surfactant-1 | | 3 | | |
| Silica | 80 | 80 | 80 | 80 |
| Silane coupling | 6.4 | 6.4 | 6.4 | 6.4 |
| agent | | | | |
| Carbon black | 5 | 5 | 5 | 5 |
| Zinc white | 2 | 2 | 2 | 2 |
| Stearic acid | 2 | 2 | 2 | 2 |
| Oil | 15 | 15 | 15 | 15 |
| Age resister | 2 | 2 | 2 | 2 |
| Wax | 2 | 2 | 2 | 2 |
| Sulfur | 2 | 2 | 2 | 2 |
| Vulcanization | 2 | 2 | 2 | 2 |
| accelerator | | | | |
| Abrasion | 100 | 98 | 100 | 101 |
| resistance (Index) | | | | |
| Braking | 100 | 98 | 104 | 106 |
| properties (Index) | | | | |
| Rolling | 100 | 104 | 94 | 96 |
| resistance (Index) | | | | |
| EB retention (Index) | 100 | 101 | 108 | 105 |
| Smell rubber | Poor | Poor | Good | Good |
| Processability | 100 | 102 | 94 | 98 |

As described above, the rubber composition according to the aspect of the present invention can be used in each site of tires, such as side wall or bead portion, including tread of tires, and further in inner liner, and particularly, can provide a pneumatic tire that reduces rolling resistance, thereby promoting low fuel consumption.

What is claimed is:

1. A rubber composition comprising a diene rubber as a rubber component, and a lignin derivative.

2. The rubber composition as claimed in claim 1, wherein the lignin derivative is lignin sulfonic acid or a lignin sulfonic acid derivative.

3. The rubber composition as claimed in claim 2, wherein the lignin sulfonic acid derivative is a lignin sulfonate.

4. The rubber composition as claimed in claim 3, wherein the lignin sulfonate comprises at least one of alkali metal salts and alkaline earth metal salts of lignin sulfonic acid.

5. The rubber composition as claimed in claims 1, wherein the lignin derivative is contained in an amount of from 0.1 to 30 parts by weight per 100 parts by weight of the rubber component.

6. The rubber composition as claimed in claims 1, wherein the composition further comprises a reinforcing agent.

7. The rubber composition as claimed in claims 6, wherein the reinforcing agent is carbon black and/or silica.

8. A pneumatic tire using the rubber composition as claimed in claim 1 in at least a part of the tire.
